(19) United States
(12) Patent Application Publication
(10) Pub. No.: US 2023/0176795 A1
(43) Pub. Date: Jun. 8, 2023

(54) PRINT JOB LIFE CYCLES

(71) Applicant: Hewlett-Packard Development Company, L.P., Spring, TX (US)

(72) Inventors: Phillip A. Mccoog, Vancouver, VA (US); Michael St. Laurent, Kitchener (CA); Joshua Ernewein, Kitchener (CA)

(73) Assignee: Hewlett-Packard Development Company, L.P., Spring, TX (US)

(21) Appl. No.: 17/921,117

(22) PCT Filed: May 8, 2020
(86) PCT No.: PCT/US2020/032058

§ 371 Date: Oct. 25, 2022

(51) Int. Cl. G06F 3/12

(52) U.S. Cl. CPC G06F 3/121; G06F 3/1254; G06F 3/1229; G06F 3/1259

(57) ABSTRACT

Example implementations relate to generating print job life cycles. For example, a cloud resource, can include instructions to: extract printer data associated with a print job from a printing device, extract application data associated with the print job from a computing device executing an application associated with the printing device, extract driver data associated with the print job rom a driver associated with the computing device, and generate a life cycle of the print job based on the printer data, application data, and driver data associated with the print job.

### BACKGROUND

Printing systems can include a plurality of devices, instructions, firmware, and/or other components that allow a printing device to receive a print job from a computing device to generate an image on print medium. In some examples, a malfunction within a particular component of the printing system can prevent the printing device from performing a print job utilizing a particular computing device.

### BRIEF DESCRIPTION OF THE DRAWINGS

FIG. 1 illustrates an example system including a cloud resource and a printing system for generating print job life cycles consistent with the present disclosure.

FIG. 2 illustrates an example of a memory resource for generating print job life cycles, in accordance with the present disclosure.

FIG. 3 illustrates an example system including a cloud resource and a printing system for generating print job life cycles consistent with the present disclosure.

FIG. 4 illustrates an example system for generating print job life cycles consistent with the present disclosure.

### DETAILED DESCRIPTION

Generating a life cycle for a work product such as a print job is described herein. Although examples of print jobs and printing systems are described herein, examples of the present disclosure are not so limited. For example, other types of systems that generate a product can utilize the systems and devices described herein to generate life cycles for the generated products. In this way, the performance of generating the product can be compared to generating other products and/or compared to generating the same product under different conditions.

In some examples, a printing device can generate an image such as text, pictures, or other features on a print medium. As used herein, a print medium can include a material that can receive a print substance from a printing device. For example, a print medium can include, but is not limited to paper, plastic, metal, among other materials. In some examples, the printing device can deposit the print substance on to specific locations of a print medium to generate the image. As used herein, a print substance can include a compound that can be deposited on the print medium by the printing device. For example, the print substance can include ink, toner, three-dimensional (3D) print ink, and/or other materials that can be deposited on a print medium to generate an image.

In some examples, a printing device can be a part of a printing system. As used herein, a printing system can include a plurality of devices or components that can be utilized to perform functions associated with generating an image on a physical print medium. For example, the printing system can include a computing device or user device that can be utilized to generate a digital image to be utilized to generate an image on the print medium. In this example, the printing system can include a plurality of intermediate devices that can be utilized to transfer the digital image to a printing device within the printing system. Thus, in order for a print job to be executed, the printing device, computing device, and/or intermediate devices of the printing system may need to operate together through the life cycle of a print job to execute the print job. As used herein, the life cycle of the print job can include data related to the print job from a beginning of the print job to the completion of the print job.

In some examples, data related to the print job can include data related to a status of a component, a timestamp when the component performed a function, a quantity of functions performed by the component, and/or other types of data that relate to executing the print job. In some examples, the data related to the print job can be extracted from separate components of the printing system and categorized together as a life cycle of a particular print job. In some examples, the print job can be assigned a unique ID in order to identify the extracted data as belonging to a particular print job. In other examples, properties of the print job are utilized to identify the extracted data as belonging to a particular print job. In this way, each print job of a plurality of print jobs that a printing system executes can include a corresponding life cycle that can be analyzed as single life cycle or as a group of life cycles for a particular printing system.

The present disclosure relates to generating print job life cycles. The print job life cycles can be utilized to identify resources that are utilized for each of a plurality of print jobs. In some examples, the identified resources can be utilized to charge clients or users of the printing system based on resources that are utilized. In other examples, the print job life cycles can be utilized to identify resources that are preferred by clients such that future printing devices can be developed that include the identified resources while eliminating resources that may not be utilized as frequently.

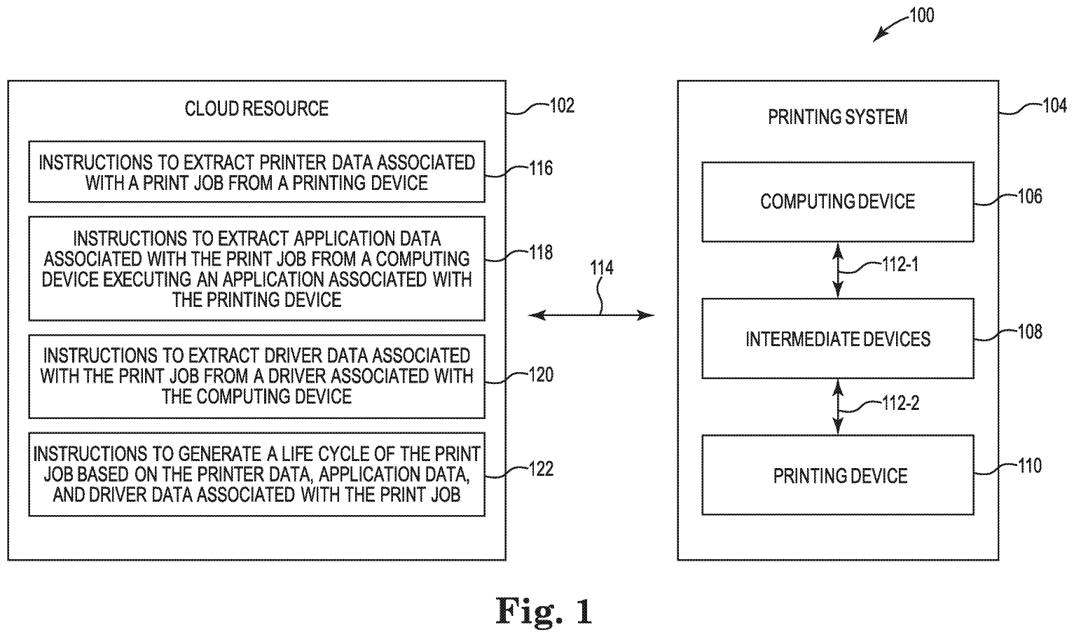

FIG. 1 illustrates an example system 100 including a cloud resource 102 and a printing system 104 for generating print job life cycles consistent with the present disclosure. In some examples, the system 100 can illustrate an example of monitoring and generating print job life cycles for a printing system 104. Although system 100 illustrates a cloud resource 102 and a printing system 104, the present disclosure is not limited to printing systems such as printing system 104. For example, the system 100 can be utilized to monitor and generate data life cycles or product life cycles for other types of systems.

The system 100 illustrates a cloud resource 102 being utilized to monitor the printing system 104 by extracting data from the components of the printing system 104 and categorizing the data to associate the extracted data with a particular print job. In this way, the extracted data from the plurality of components of the printing system 104 can be utilized to generate print job life cycles for print jobs executed by the printing system 104. In some examples, the printing system 104 can include a computing device 106, a printing device 110, and/or a plurality of intermediate devices 108. In some examples, the printing system 104 can be a system that is utilized to generate and execute print jobs.

In some examples, the computing device 106 can be utilized to generate a digital image to be printed as a physical image on the print medium. In these examples, the computing device 106 can utilize the intermediate devices 108 to provide the digital image to the printing device 110 such that the printing device 110 can generate the image on a print medium. For example, the intermediate devices 108 can include communication pathways, drivers, cloud services, and/or other components that can be utilized to provide a print job from the computing device 106 to the printing device 110. As used herein, a print job can include data and/or information related to producing and executing a print job. For example, a print job can include data related to the digital image to be printed, drivers utilized to convert the digital image to printing instructions for the printing device 110, communication pathways utilized to transfer the digital image to the printing device 110, settings of the printing device 110 to generate the image on the print medium, and/or other data that is utilized to generate the image on the print medium. As used herein, the life cycle of a print job can include data from a start of the print job through a completion of the print job.

In some examples, a life cycle can exist or be generated for each of a plurality of print jobs. For example, the printing device 110 can receive a plurality of separate print jobs from the computing device 106 and/or other devices communicatively coupled to the printing device 110. In this example, each of the plurality of separate print jobs can include a corresponding life cycle. In some examples, the life cycle of a plurality of print jobs can be used to determine a quantity of use for particular components of the printing system 104 and/or identify components of the printing system 104 that are utilized to perform print jobs. In this way, the cloud resource 102 can monitor a print job from initiation to completion. In some examples, the cloud resource 102 can generate a unique identification (ID) that is assigned to a particular print job. In other examples, a unique ID can be generated upon the initiation or start of a print job and the unique ID can be utilized throughout the print job life cycle to identify the print job from the start to the completion. In this way, the cloud resource 102 can extract data from components of the printing system 104 and categorize the extracted data based on a print job that is associated with the data.

In other examples, the cloud resource 102 can utilize features of a print job to identify extracted data that corresponds to a particular print job. For example, the cloud resource 102 can identify a page count for a particular print job. In this example, the cloud resource 102 can utilize the page count to determine what pages or output pages from the printing device 110 correspond to the particular print job and what pages from the printing device 110 correspond to a different print job. In this way, the cloud resource 102 can extract data from a plurality of components of the printing system 104 and categorize the extracted data into portions, where each portion of data corresponds to a particular print job. In these examples, the extracted data for each print job can be organized to generate a life cycle for the plurality of print jobs such that each life cycle includes extracted data from components of the printing system 104 that was utilized to execute the print job. For example, the cloud resource 102 can extract printer data, driver data, and/or application data. In this example, the printer data can include data local to the printing device 110, the application data can include data local to the computing device 106, and the driver data can include data local to the driver utilized from the intermediate devices 108.

In some examples, the cloud resource 102 can include instructions 116, 118, 120, 122. In some examples, the cloud resource 102 can be a remote computing device that includes a memory resource to store the instructions 116, 118, 120, 122 and the instructions 116, 118, 120, 122 can be executed by a processing resource (e.g., central processing unit (CPU), processor, etc.) to monitor the printing system 104 and/or generate print job life cycles for a plurality of print jobs executed by the printing system 104.

In some examples, the cloud resource 102 can include instructions 116 to extract printer data associated with a print job from a printing device 110. As used herein, printer data is data extracted from or generated by the printing device 110, where the data is utilized by the printing device 110 to execute a print job. For example, the printer data can include, but is not limited to: a timestamp of print job initiation, a quantity of resources (e.g., ink, media, time, power, etc.) utilized to generate the print job, a device identification that provided the print job, settings and/or finishing processes performed for the print job (e.g., color, duplicated, stapled, etc.), and/or other data related to the printing device 110 executing the print job.

As described herein, the cloud resource 102 can be utilized to extract data from the printing device 110. In some examples, the cloud resource 102 can utilize data extracted from the printing device to determine a performance of a plurality of different print jobs. In some examples, a print job can be assigned a unique ID that can utilized within meta data, headers, and/or other areas of the print job data, such that the cloud resource 102 can identify particular data that is extracted from the printing device 110 to be associated with a corresponding print job. In this way, data can be extracted from the printing device 110 for a plurality of different print jobs and the extracted data can be categorized into different print jobs by utilizing the unique ID.

In other examples, a unique ID may not be utilized throughout each component of the printing system 104. For example, the same unique ID may not be transferred with data from an initiation of the print job to the completion of the print job. In a specific example, the computing device 106 can be utilized to generate a print job with a unique ID that can be utilized by the computing device 106 to log the print job. In this example, the unique ID utilized by the computing device 106 may not be transferred to or utilize by the intermediate devices 108 of the printing system 104. In this example, the cloud resource 102 can utilize data extracted from the computing device 106 to identify the print job data that is extracted from the intermediate devices 108. In this way, the cloud resource 102 can be utilized to identify a corresponding print job for extracted data from a plurality of components associated with the printing system 104.

In some examples, the cloud resource 102 can include instructions 118 to extract application data associated with the print job from a computing device 106 executing an application associated with the printing device 110. In some examples, the application data can be data related to an application that is utilized to generate a digital image to be utilized to generate the image on a print medium by a printing device 110. In some examples, the application data can include, but is not limited to: a type of application utilized, a timestamp, a user profile associated with the application utilized, a plurality of settings associated with generating the print job, and/or other data that can be utilized by an application and/or computing device to generate the print job.

In some examples, the extracted application data can be utilized by the cloud resource to identify a print job across the printing system 104. For example, the extracted application data can be utilized to identify a start or initiation of a print job and an end or completion of the print job. In this way, the data that is extracted from the start to the end of the print job can be utilized and stored as relating to the print job. In addition, the cloud resource 104 can utilize the data extracted from the printing system 104 to track the print job as the print job is processed through the computing device 106, intermediate devices 108, and/or the printing device 110. For example, the cloud resource 102 can determine that a print job with a particular quantity of pages has been generated and the cloud resource 102 can utilize the particular quantity of pages to identify when the printing device 110 has begun the print job and when the printing device 110 has completed the print job. In a similar way, the cloud resource 102 can utilize the data extracted from the computing device 106 to identify data associated with the print job when the print job is transferred to the intermediate device 108 and/or transferred to the printing device 110. For example, the data extracted from the computing device 106 can be utilized to identify a portion of the intermediate devices 108 that are to be utilized to transfer the digital image to the printing device 110.

In some examples, the cloud resource 102 can include instructions 120 to extract driver data associated with the print job from a driver associated with the computing device 106. As used herein, a driver can include instructions that enable hardware devices to communicate with a computing device operating system. For example, a driver can include instructions (e.g., software, firmware, etc.) to allow an operating system or application being executed by the computing device 106 to communicate with other hardware devices of the printing system 104. For example, a driver can be an intermediate device 108 that allows the computing device 106 to transfer a print job to the printing device 110 such that the printing device 110 can generate an image on the print medium according to the digital image generated by the computing device 106.

In some examples, the driver data can include data related to the performance or execution of the driver when a print job is initiated by the computing device 106 or user device. In some examples, the cloud resource 102 can categorize the driver data based on the print job associated with the driver data. As described herein, the print job can include a unique ID that can be utilized by the cloud resource 102 to identify the print job associated with the driver data. However, in some examples, the unique ID may not be generated for a print job and/or may not be utilized by the intermediate devices 108, such as a driver. In these examples, the cloud resource 102 can utilize extracted data from other components of the printing system 104 to identify data that corresponds to particular print jobs. For example, the cloud resource 102 can utilize time stamp data from the computing device 106 and/or the printing device 110 to identify a time period that the intermediate devices 108 were processing the data associated with a particular print job. In this example, the cloud resource can extract data from a driver or other intermediate device 108 and compare a time stamp of the extracted data to further categorize the extracted data into a particular print job life cycle. In some examples, other data extracted by the cloud resource 102 and/or a combination of data extracted by the cloud resource 102 can be utilized to track or identify data that is associated to a particular print job.

For example, the cloud resource 102 can utilize a timestamp, a quantity of pages to be printed, and a quantity of copies to identify a print job being processed by the intermediate devices 108. In this example, the time stamp can be utilized to identify when the intermediate devices 108 are likely to have begun processing the print job, the quantity of pages can be utilized to identify when the quantity of pages have been processed by the intermediate devices 108, and/or the quantity of copies can be utilized to identify when each copy has been processed by the intermediate devices 108. In this way, the cloud resource 102 can track and/or identify data associated with a particular print job and utilize only the extracted data associated with the print job to generate a life cycle for the print job.

In some examples, the cloud resource 102 can include instructions 122 to generate a life cycle of the print job based on the printer data, application data, and driver data associated with the print job. As described herein, the cloud resource 102 can generate a life cycle for the print job based on the extracted data. In some examples, generating the life cycle of the print job can include organizing extracted data such that extracted data relating to the print job is included within the life cycle and extracted data relating to other print jobs are excluded from the life cycle of the print job. In some examples, the life cycle of the print job can include calculated metrics based on the extracted data. For example, a starting time for the print job can be determined based on data extracted from the computing device 106. In this example, the completion time for the print job can be determined based on data extracted from the printing device 110. Thus, in this example, a quantity of time for the print job can be calculated based on the starting time and completion time of the print job.

In some examples, the generated life cycle can include a single view representation from a starting point of the print job to a finishing point of the print job. That is, the life cycle can be displayed on a user interface as a single view to illustrate the extracted data and/or calculations based on the extracted data in a single window of the display. In some examples, the single view can include a timeline that has a starting point at an initiation time of the print job and an ending point at a completion time of the print job. In some examples, the life cycle of the print job can be utilized in a variety of ways. For example, the life cycle of the print job can be utilized to calculate a cost to a user associated with the print job based on the life cycle of the print job, alter settings of the printing system 104 for a second print job based on the life cycle for the first print job, compare a performance of the print job to an additional print job based on the corresponding life cycles, identify a rate limiting step of a print job, predict a rate limiting step of a first print job based on a comparison of the performance with a second print job, and/or other determinations that can be utilized to improve the printing system 104 and/or business associated with the printing system 104.

In some examples, a cost to a user associated with a print job can be performed for a printing system 104 or printing device 110 that provides services to the user on a use basis. That is, the cloud resource 102 can be utilized to determine a usage of components (e.g., drivers, intermediate devices 108, etc.) and/or resources (e.g., toner, ink, electricity, etc.) for a particular print job based on a print job life cycle of the print job. In these examples, the cost can be a charge or bill to charge the user based on the life cycle of the print job.

In other examples, the life cycle of a print job can be utilized to compare the print job to other print jobs. In some examples, this comparison can be utilized to determine an efficiency of a particular print job compared to an efficiency of a different print job. In this way, future business decisions can be made based on the life cycles of a plurality of print jobs executed by the printing system 104. For example, the comparison can be utilized to identify elements or components of the printing system 104 that are used more frequently, components of the printing system 104 that are rate limiting, and/or components of the printing system 104 that fail relatively more often. As used herein, a rate limiting step or rate limiting device can be a step of the life cycle of a print job that takes a relatively larger quantity of time or prevents the printing system 104 from completing the print job in a relatively smaller quantity of time. In this way, printing systems, such as printing system 104 can be utilized by a plurality of users and/or organizations while also providing insight into updates or upgrades that could be valuable to the printing system 104.

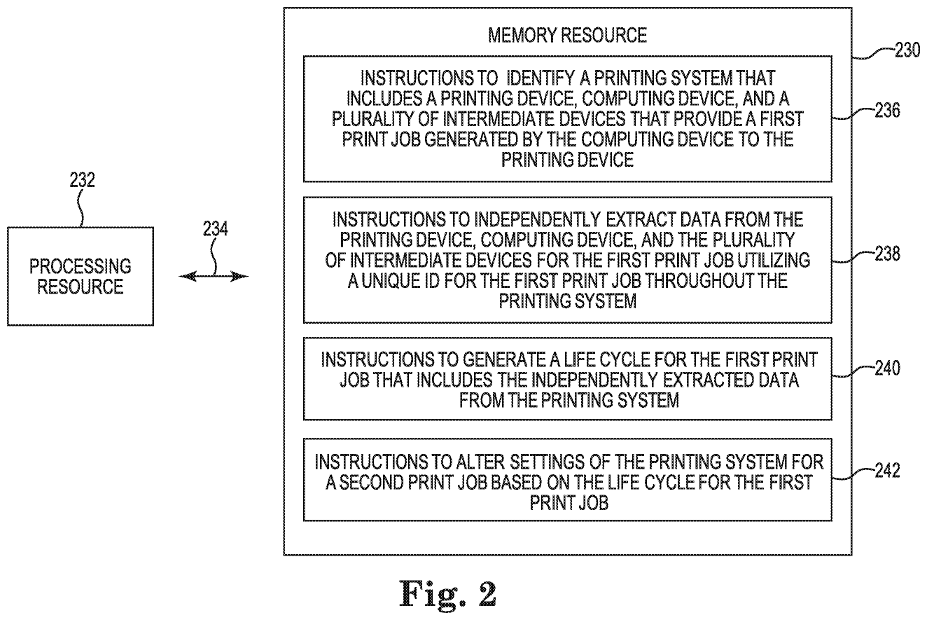

FIG. 2 illustrates an example of a memory resource 230 for generating print job life cycles, in accordance with the present disclosure. In some examples, the memory resource 230 can be a part of a computing device or controller that can be communicatively coupled to a printing system, printing device, and/or intermediate device within the printing system. For example, the memory resource 230 can be part of a cloud resource 102 as referenced in FIG. 1 and communicatively coupled to a printing system 104 as referenced in FIG. 1. In some examples, the memory resource 230 can be communicatively coupled to a processing resource 232 that can execute instructions 236, 238, 240, 242 stored on the memory resource 230. For example, the memory resource 230 can be communicatively coupled to the processing resource 232 through a communication path 234. As used herein, a communication path 234 can include a wired or wireless connection that can allow communication between devices.

The memory resource 230 may be electronic, magnetic, optical, or other physical storage device that stores executable instructions. Thus, non-transitory machine readable medium (e.g., a memory resource 230) may be, for example, a non-transitory MRM comprising Random Access Memory (RAM), an Electrically-Erasable Programmable ROM (EEPROM), a storage drive, an optical disc, and the like. The non-transitory machine readable medium (e.g., a memory resource 230) may be disposed within a controller and/or computing device. In this example, the executable instructions 236, 238, 240, 242 can be “installed” on the device. Additionally, and/or alternatively, the non-transitory machine readable medium (e.g., a memory resource 230) can be a portable, external or remote storage medium, for example, that allows the system to download the instructions 236, 238, 240, 242 from the portable/external/remote storage medium. In this situation, the executable instructions may be part of an “installation package”. As described herein, the non-transitory machine readable medium (e.g., a memory resource 230) can be encoded with executable instructions for array droplet manipulations.

The instructions 236, when executed by a processing resource such as the processing resource 232, can cause the processing resource to identify a printing system that includes a printing device, computing device, and a plurality of intermediate devices that provide a first print job generated by the computing device to the printing device. As described herein, a printing system (e.g., printing system 104 as illustrated in FIG. 1, etc.) can include a printing device (e.g., printing device 110 as illustrated in FIG. 1, etc.) that is communicatively coupled to a computing device (e.g., computing device 102 as illustrated in FIG. 1, etc.) through a plurality of intermediate devices that provide for communication between the computing device and the printing device.

In some example, identifying the printing system can include identifying or mapping the components of a printing system. For example, the printing system can include a computing device or plurality of computing devices that are each coupled to a printing device. In this example, the computing device can communicate or transmit print jobs to the printing device through intermediate devices (e.g., drivers, communication connections, cloud resources, etc.). In this example, the printing system can be identified by mapping the computing device to the printing device for a plurality of different types of print jobs. In this example, different types of print jobs can utilize a different intermediate device or combination of intermediate devices. Thus, the mapping or printing system identification can be utilized to identify a life cycle of print job from a start to a completion of the print job.

The instructions 238, when executed by a processing resource such as the processing resource 232, can cause the processing resource to independently extract data from the printing device, computing device, and the plurality of intermediate devices for the first print job utilizing a unique ID for the first print job throughout the printing system. As described herein, a print job can utilize a unique ID that can be transferred to the different intermediate devices throughout the life cycle of the print job. In these examples, the data from the printing device, computing device, intermediate devices, and/or other devices associated with the printing system can be independently extracted. In these examples, the data can be extracted from each of the plurality of components of the printing system independently and categorized or organized based on the unique ID associated with the print job.

The instructions 240, when executed by a processing resource such as the processing resource 232, can cause the processing resource to generate a life cycle for the first print job that includes the independently extracted data from the printing system. As described herein, generating the life cycle for the first print job can include organizing the data extracted from the components of the printing system, identifying the unique ID of the first print job, and generating a life cycle for the first print job utilizing the data generated throughout the life cycle of the first print job. In some examples, the life cycle of the first print job can be unique to the first print job. For example, the first print job can utilize a first computing device, a first portion of intermediate devices, and/or a first portion of functions on the printing device. In this example, a second print job can utilize a second computing device, a second portion of the intermediate devices, an/or a second portion of functions on the printing device, which will result in a second print job life cycle for the second print job.

In some examples, the life cycle of a first print job can be utilized to improve settings of the printing device for future print jobs that include similar settings or data as the first print job. For example, the life cycle of the first print job can be utilized to identify a rate limiting step or rate limiting component. In this example, the identified rate limiting step or rate limiting component can be utilized to identify settings that can be altered that may affect the rate limiting state and/or rate limiting component. In this way, the setting can be altered prior to a second print job being executed. In other examples, the identified rate limiting step or rate limiting component can be provided as a notification to a user upon initiation of a second print job that includes similar settings as the first print job. In this way, a setting or component can be updated or altered to increase the performance of the second print job.

The instructions 242, when executed by a processing resource such as the processing resource 232, can cause the processing resource to alter settings of the printing system for a second print job based on the life cycle for the first print job. In some examples, the settings of the printing system can include altering settings of a printing component either prior or during a life cycle of a print job. For example, altering a setting of the printing system for a second print job can include altering a setting of the printing system prior to or during the life cycle of the second print job. In a specific example, a rate limiting step of utilizing multi-color versus mono-color for a first print job can be utilized to alter a color setting from multi-color to mono-color to increase a performance of the second print job.

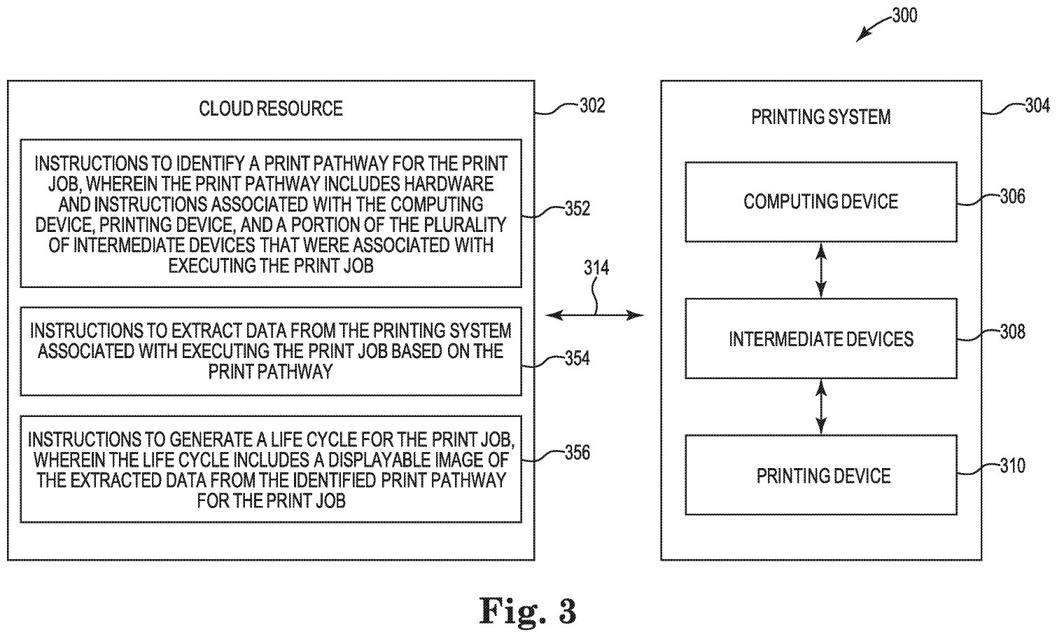

FIG. 3 illustrates an example system 300 including a cloud resource 302 and a printing system 304 for generating print job life cycles consistent with the present disclosure. In some examples, the system 300 can illustrate an example of monitoring and generating print job life cycles for a printing system 304. The system 300 illustrates a cloud resource 302 being utilized to monitor the printing system 304 by collecting data from the components of the printing system 304. In some examples, the system 300 can include the same or similar elements as system 100 as referenced in FIG. 1 and/or utilize a memory resource that is the same or similar as the memory resource 230 as referenced in FIG. 2.

In some examples, the cloud resource 302 can include instructions 352, 354, 356. In some examples, the cloud resource 302 can be a remote computing device that includes a memory resource to store the instructions 352, 354, 356 and the instructions 352, 354, 356 can be executed by a processing resource (e.g., central processing unit (CPU), processor, etc.) to monitor the printing system 304 and/or generating print job life cycles for print jobs executed by the printing system 304. In some examples, the computing device 306 can include instructions 352, 354, 356 that can be executed by a processing resource to perform corresponding functions.

In some examples, the cloud resource 302 can include instructions 352 to identify a print pathway for the print job, wherein the print pathway includes hardware and instructions associated with the computing device 306, printing device 310, and a portion of the plurality of intermediate devices 308 that were associated with executing the print job. As used herein, a print pathway for a print job includes the hardware and software utilized from a start the print job to the completion the print job. For example, the print pathway can include a computing device 306 and application that generates the print job, a communication path (e.g., portion of intermediate devices 308, etc.) to transfer the generated print job to a printing device, and the printing device 310 utilized to execute and complete the print job. As described herein, the print pathway can be identified utilizing a mapping of the printing system. In some examples, the print pathway and/or mapping of the printing system can be generated based on extracted data from a plurality of print jobs performed on the printing system. In other examples, the print pathway and/or a mapping of the printing system can be based on running performance tests on the printing system.

In some examples, the cloud resource 302 can include instructions 354 to extract data from the printing system 304 associated with executing the print job based on the print pathway. In some examples, the print pathway and/or mapping of the printing system can be utilized to identify components of the printing system 304 that are utilized to execute the print job. In these examples, the cloud resource 302 can extract data from the identified components of the print pathway. In some examples, the print job can be analyzed by the cloud resource 302 to identify the components of the printing system 304 that will be utilized to execute the print job. In these examples, the cloud resource 302 can independently extract data from the identified components as described herein.

In some examples, the cloud resource 302 can include instructions 356 to generate a life cycle for the print job, wherein the life cycle includes a displayable image of the extracted data from the identified print pathway for the print job. As described herein, the print job life cycle can include data that corresponds to the print job to illustrate how and/or how efficiently the print job was executed by the printing system 304. For example, the life cycle can include a displayable image of categorized extracted data from the printing system 310 and/or calculations that are based on the extracted data from the printing system 310. In some examples, a displayable image of the extracted data can include a timeline of the extracted data based on a time stamp of the corresponding data.

Since the data is extracted from the plurality of components independently, organizing the data along a timeline based on a corresponding timestamp can make the displayable image of the life cycle easier to utilize and/or identify rate limiting steps or components as described herein. For example, the time line of data can illustrate greater gaps in areas that took a relatively greater quantity of time to execute. In this way, events (e.g., errors, malfunctions, etc.) an be more easily identified utilizing the print job life cycle. In addition, generating print job life cycles with a unified format can allow print jobs to be more easily compared, which can allow setting changes to be identified that could increase performance. In other examples, the print job life cycle can be utilized to calculate a cost to charge a user that executed the print job. As described herein, the printing system 304 can be utilized as a pay for service device that allows a user to utilize the printing system 304 and pay for the service utilized. In these examples, the life cycle can be provided to a user to help explain the components utilized by the print job and assess a corresponding charge for the components utilized.

In other examples, the cloud resource 302 can include instructions to generate a recommendation based on the rate limiting step of the life cycle. In some examples, the recommendation can indicate a setting change or hardware change related to the printing system 304. For example, the recommendation can be in response to a first driver taking a relatively longer time to execute than a second driver In this example, the recommendation can include a displayable notification to a user that the second driver should be utilized to perform the next print job. In another example, the recommendation can: suggest applications to utilize based on the extracted application data, suggest drivers to utilize based on the extracted driver data, and/or suggest a printing device based on the extracted printer data.

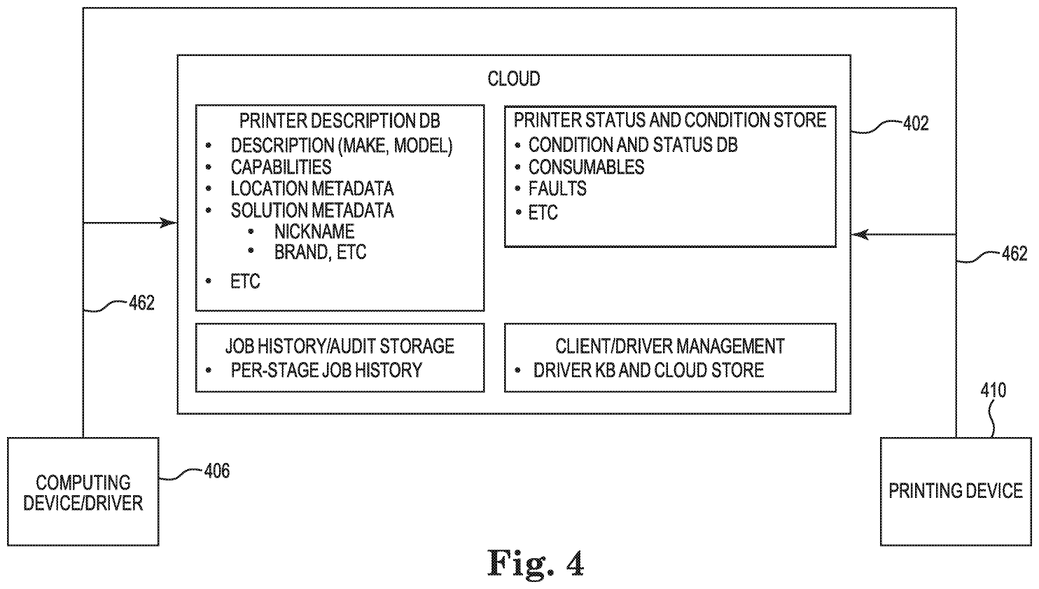

FIG. 4 illustrates an example system 400 including a cloud resource 402 and a printing device 410 for generating print job life cycles consistent with the present disclosure. In some examples, the system 400 can include the same or similar elements as system 100 as referenced in FIG. 1 and/or system 300 as referenced in FIG. 3. In some examples, the system 400 can be utilized to monitor a printing system that includes a printing device 410 and/or a computing device 406.

In some examples, the system 400 can include a printing device 410. Although a printing system utilizing a printing device 410 are illustrated as examples, the present disclosure is not limited to printing systems. For example, other types of systems that utilize computing devices and/or other mechanical devices can utilize similar systems and devices described herein. In some examples, the printing device 410 can be part of a printing system. In some examples, the printing system can include a computing device 406 that can generate digital images that can be utilized to generate physical representations of the digital images utilizing the printing device 410.

In some examples, the system 400 can include a cloud resource 402 that can be utilized as part of the printing system and/or can be utilized to generate print job life cycles as described herein. In some examples, the cloud resource 402 can be a portion of the intermediate devices utilized by the printing system to transfer digital images from the computing device 406 to the printing device 410. In one example, the computing device 406 can utilize a communication pathway 462 to directly send or provide digital images to the printing device 410. In this example, the communication pathway 462 can be part of the intermediate devices utilized to transfer the digital images from the computing device 406 to the printing device 410. In other examples, the computing device 406 can send a print job to the cloud resource 402 and the cloud resource 402 can provide the print job to the printing device 410. In these examples, the cloud resource 402 can part of the intermediate devices as described herein.

In some examples, the cloud resource 402 can include a printer description database that can be utilized to store information related to the printing device 410. For example, the printer description database can include, but is not limited to: a description of the printing device 410, a make and model of the printing device 410, a location and/or solution of metadata associated with the printing device 410, and/or other information or data related to the printing device 410 functionality or capabilities. In some examples, the cloud resource 402 can include a printer status database that can include data related to a condition of the printing device 410, a current status of the printing device 410, status on consumables (e.g., ink, toner, etc.) and/or detected faults form the printing device 410. In some examples, the cloud resource 402 can include a client/driver management database to manage user devices, such as computing device 406 and/or drivers associated with the computing device 406. In some of these examples, the cloud resource 406 can utilize a job history database to store generated print job life cycles for a plurality of print jobs associated with the printing system.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “N”, particularly with respect to reference numerals in the drawings, indicates that a number of the particular feature so designated can be included with examples of the present disclosure. It is also to be understood that the terminology used herein is for the purpose of describing particular examples only and is not intended to be limiting. As used herein, the singular forms “a,” “an,” and “the” can include both singular and plural referents, unless the context clearly dictates otherwise. The designators can represent the same or different numbers of the particular features. Further, as used herein, “a number of” an element and/or feature can refer to one or more of such elements and/or features.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A cloud resource, comprising instructions to:
extract printer data associated with a print job from a printing device;
extract application data associated with the print job from a computing device executing an application associated with the printing device;
extract driver data associated with the print job from a driver associated with the computing device;
generate a life cycle of the print job based on the printer data, application data, and driver data associated with the print job; and
alter settings of the printing device based on the life cycle of the print job.

2. The cloud resource of claim 1, comprising instructions to calculate a cost to a user associated with the print job based on the life cycle of the print job.

3. The cloud resource of claim 1, wherein the printer data includes data collected by the printing device, the application data includes data collected by an application generating the print job, and the driver data includes data collected by a driver that received the print job from the application.

4. The cloud resource of claim 1, comprising instructions to categorize the printer data, application data, and driver data to be associated with the print job based on features of the print job.

5. The cloud resource of claim 1, wherein the life cycle includes the printer data, application data, and driver data aggregated as data associated with a unique ID associated with the print job.

6. The cloud resource of claim 1, wherein the life cycle includes a single view representation from a starting point of the print job to a finishing point of the print job.

7. The cloud resource of claim 1, wherein the printer data includes data local to the printing device, the application data includes data local to the computing device, and the driver data includes data local to the driver.

8. A non-transitory machine-readable storage medium comprising instructions executable by a processing resource to:
identify a printing system that includes a printing device, computing device, and a plurality of intermediate devices that provide a first print job generated by the computing device to the printing device;
independently extract data from the printing device, computing device, and the plurality of intermediate devices for the first print job utilizing a unique ID for the first print job throughout the printing system;
generate a life cycle for the first print job that includes the independently extracted data from the printing system; and
alter settings of the printing system for a second print job based on the life cycle for the first print job.

9. The medium of claim 8, further comprising instructions executable to identify a portion of the plurality of intermediate devices that are utilized by the first print job.

10. The medium of claim 9, further comprising instructions executable to extract data from the identified portion of the plurality of intermediate devices that are utilized by the first print job, wherein the intermediate devices that are not part of the identified portion were not utilized by the first print job.

11. The medium of claim 9, further comprising instructions executable to categorize the life cycle based on the portion of the plurality of intermediate devices that are utilized by the first print job.

12. The medium of claim 8, wherein the extracted data from the computing device includes data extracted from an application that generated a digital image of the first print job.

13. A system, comprising:
a printing system that includes a computing device communicatively coupled to a printing device through a plurality of intermediate devices, wherein the plurality of intermediate devices facilitate transmission of a print job from the computing device to the printing device; and
a cloud resource, comprising instructions to:
identify a print pathway for the print job, wherein the print pathway includes hardware and instructions associated with the computing device, printing device, and a portion of the plurality of intermediate devices that were associated with executing the print job;
extract data from the printing system associated with executing the print job based on the print pathway; and
generate a life cycle for the print job, wherein the life cycle includes a displayable image of the extracted data from the identified print pathway for the print job.

14. The system of claim 13, wherein the cloud resource includes instructions to:
generate an additional life cycle for an additional print job;
compare a performance of the print job to the additional print job based on the corresponding life cycles; and
identify a rate limiting step of the additional print job based on the comparison of the performance.

15. The system of claim 13, wherein the cloud resource includes instructions to:
identify a rate limiting step of the life cycle; and
generate a recommendation based on the rate limiting step of the life cycle.
